(19) United States
(12) Patent Application Publication
(10) Pub. No.: US 2006/0092231 A1
(43) Pub. Date: May 4, 2006

(54) Fluid injection device and method of fabricating the same

(75) Inventors: Chung-Cheng Chou, Lujhu Township (TW); Tsung-Ping Hsu, Jungli City (TW); Shang-Shi Wu, Chiai (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/265,050

(22) Filed: Nov. 2, 2005

(30) Foreign Application Priority Data
Nov. 2, 2004 (TW) 93133330

(51) Int. Cl. B41J 2/05

(52) U.S. Cl. 347/56

(57) ABSTRACT

A fluid injection device. The device includes a substrate, a chamber formed in the substrate, and a structural layer covering the substrate and the chamber, wherein the structural layer covering the chamber has two regions with different thicknesses, and at least two nozzles pass through the two structural layer regions respectively and connected to the chamber. The method of fabricating the above fluid injection device is also disclosed.

### BACKGROUND

The present invention relates to a fluid injection device, and more specifically to a fluid injection device with altered injection quantity and a method of fabricating the same.

Currently, fluid injection devices with altered injection quantity are widely used to increase combustion efficiency in micro fuel oil engines or to improve color levels in ink jet printers. Ink jet printers and the like, such as fax or multiple function printers, for example, can either print a high color-level on plain paper or photo paper (with less injection quantity) or increase print speed thereof (with higher injection quantity) by controlling the size of injected droplets.

A related art fluid injection device is disclosed, for example, in U.S. Pat. No. 6,588,878 and illustrated in FIG. 1. The fluid injection device alters the size of the droplets (162 and 164) by varying the chamber size, the distance between the heaters and the nozzles (166 and 168), or the nozzle size in addition to using the heaters (136, 138, 142, and 144) to produce double bubbles (152, 154 and 156, 158) and eliminate satellite droplets.

Fluid injection devices with altered injection quantity can effectively improve injection quality in such as word or image processing systems, fuel injection systems, or drug injection systems. Thus, a fluid injection device capable of altering fluid injection quantity, driven by a fixed amount of power to meet industry requirements is desirable.

### SUMMARY

The invention provides a fluid injection device which can inject an altered fluid quantity in a fixed driving condition by selecting various structural layer materials or altering thicknesses thereof.

The invention provides a fluid injection device comprising a substrate, a chamber formed in the substrate, and a structural layer covering the substrate and the chamber, wherein the structural layer covering the chamber has two regions with different thicknesses, and at least two nozzles are formed through the two structural layer regions respectively and connected to the chamber.

The invention also provides a fluid injection device comprising a substrate, a chamber formed in the substrate, and a first structural layer covering the substrate and the chamber. The first structural layer covering the chamber has a thicker region with thickness (h1) and a thinner region with thickness (h2), a second structural layer with thickness (h3) is deposited on the thinner first structural layer, and at least two nozzles are formed through the two structural layer regions respectively and connected to the chamber.

The invention further provides a method for fabricating the fluid injection device, comprising the following steps. First, a substrate is provided. A patterned sacrificial layer is then formed on the substrate, wherein the patterned sacrificial layer is a predetermined region of a chamber. Next, a patterned structural layer is formed on the substrate to cover the patterned sacrificial layer. A patterned photoresist layer is then formed on the patterned structural layer. Next, the patterned structural layer uncovered by the patterned photoresist layer is etched to form two structural layer regions with different thicknesses and covers the patterned sacrificial layer. The patterned photoresist layer is then removed. Next, a manifold is formed through the substrate to expose the patterned sacrificial layer. The patterned sacrificial layer is then removed to form a chamber. Finally, the structural layer is etched to form at least two nozzles through the two structural layer regions respectively and connected to the chamber.

The invention provides another method of fabricating the fluid injection device, comprising the following steps. First, a substrate is provided. A patterned sacrificial layer is then formed on the substrate. The patterned sacrificial layer is a predetermined region of a chamber. Next, a first structural layer with heat transfer coefficient (k1) is formed on the substrate to cover the patterned sacrificial layer. A patterned photoresist layer is then formed on the first structural layer. Next, the first structural layer uncovered by the patterned photoresist layer is etched to form a thicker region with thickness (h1) and a thinner region with thickness (h2) and covers the patterned sacrificial layer. Next, a second structural layer with heat transfer coefficient (k2) and thickness (h3) is deposited on the thinner first structural layer. The patterned photoresist layer is then removed. A manifold is then formed through the substrate to expose the patterned sacrificial layer. The patterned sacrificial layer is then removed to form a chamber. Finally, the first and second structural layers are etched to form at least two nozzles through the two structural layer regions respectively and connected to the chamber.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross section of a related fluid injection device.

FIG. 2A is a top view of a fluid injection device of the invention.

FIGS. 2B˜2F are cross sections illustrating the fabrication process of a fluid injection device of the invention.

FIG. 3 is a diagram plotting thickness of a structural layer against a driving condition of a fluid injection device of the invention.

FIGS. 4A˜4B are cross sections of a fluid injection device of the invention.

FIGS. 5A˜5H are cross sections illustrating the fabrication process of a fluid injection device of the invention.

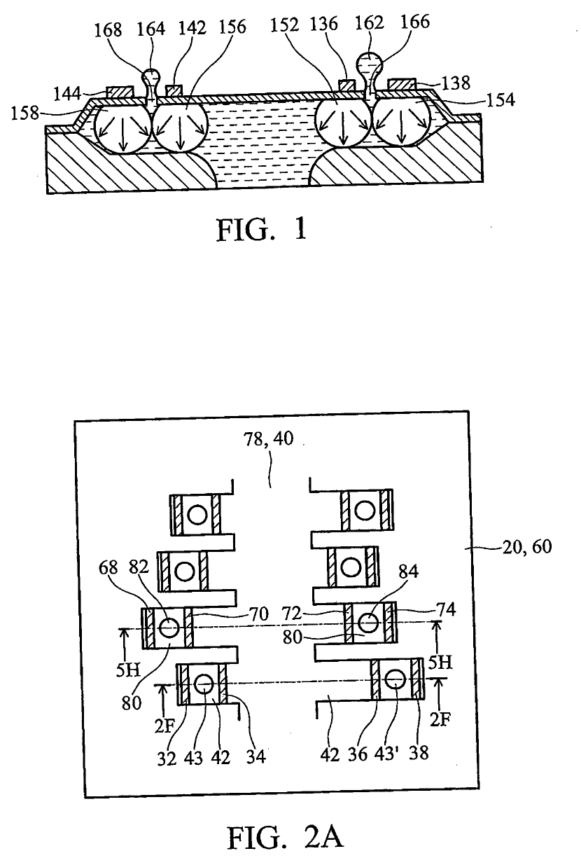

### DETAILED DESCRIPTION

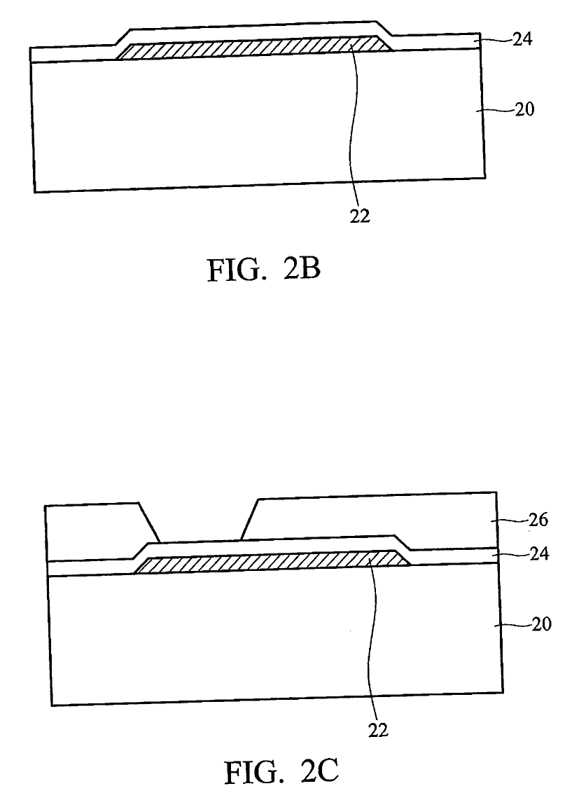

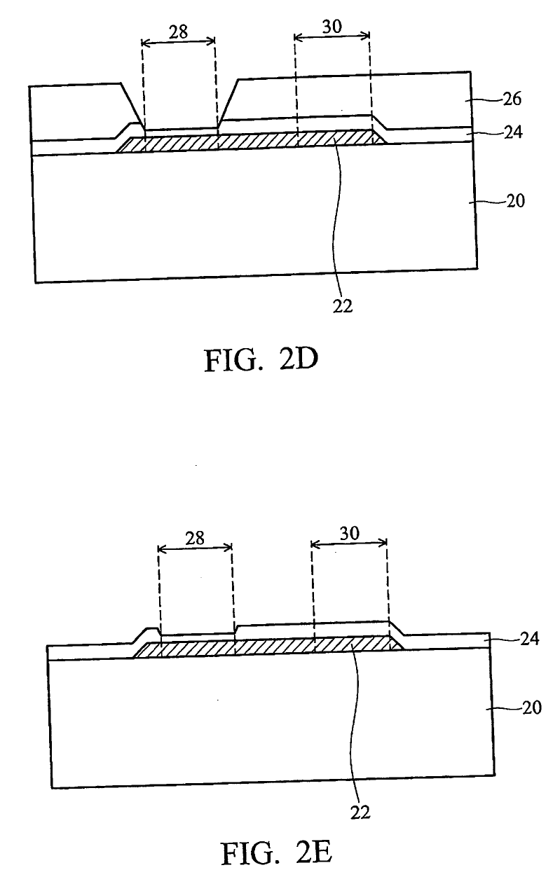

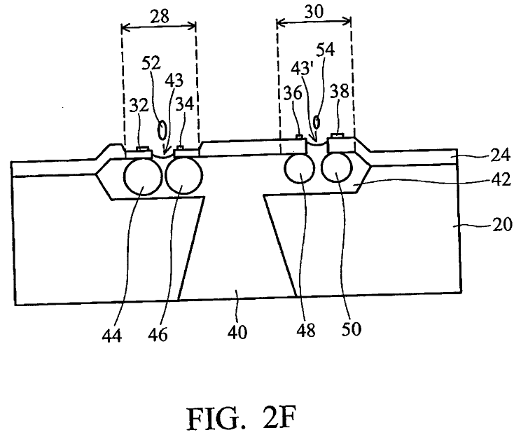

The first feature of the fluid injection device of the invention is illustrated in FIGS. 2A and 2F, wherein FIG. 2F is a cross section along the tangent line 2F-2F of FIG. 2A. Referring to FIG. 2F, the structural layer 24 covering the chamber 42 has two regions (28 and 30) with different thicknesses, that is, the device provides two operating units to exhibit different heating and injection phenomena.

The above device structure is illustrated in FIG. 2F. The fluid injection device comprises a substrate 20, a manifold 40, a chamber 42, a structural layer 24 with altered thicknesses, two sets of heaters (32, 34 and 36, 38), and a pair of nozzles (43 and 43′).

The structural layer 24 covers the substrate 20 and the chamber 42. The heaters (32, 34 and 36, 38) are installed on the structural layer 24 with different thicknesses respectively and on both sides of the nozzles (43 and 43′). The nozzles (43 and 43′) are formed through the structural layer 24 with different thicknesses respectively and connected to the chambers 42.

Referring to FIG. 2B˜2F, a method of fabricating the fluid injection device is provided. First, referring to FIG. 2B, a substrate 20 such as a silicon substrate is provided. The thickness of the substrate 20 is about 625˜675 μm. Subsequently, a patterned sacrificial layer 22, a predetermined region of a chamber, is formed on the substrate 20. The sacrificial layer comprises BPSG, PSG, or silicon oxide, preferably PSG. The thickness of the sacrificial layer is about 1˜2 μm.

Next, a patterned structural layer 24 is formed on the substrate 20 to cover the patterned sacrificial layer 22. The structural layer 24 may be silicon nitride formed by CVD. The thickness of the structural layer 24 is about 1.5˜2 μm. Subsequently, referring to FIG. 2C, a patterned photoresist layer 26 is formed on the structural layer 24. Next, the structural layer 24 uncovered by the patterned photoresist layer 26 is etched to form two regions (28 and 30) with different thicknesses, wherein the thickness variation therebetween is greater than 3500 Å, as shown in FIG. 2D. Various levels of heat transfer efficiency of the structural layer 24 is thus produced due to the thickness variation thereof.

Next, referring to FIG. 2E, the patterned photoresist layer 26 is removed. The two sets of heaters (32, 34 and 36, 38) using for driving fluid are then installed on the structural layer regions (28 and 30) respectively and on both sides of subsequently formed nozzles. The heaters (32, 34 and 36, 38) comprise HfB₂, TaAl, TaN, or TiN, and are preferably TaAl.

Subsequently, a series of etching steps are performed. First, the back of the substrate 20 is etched to form a manifold 40 by anisotropic wet etching using an etching solution, such as NaOH, to expose the patterned sacrificial layer 22. The narrow opening width of the manifold 40 is about 160˜200 μm, and the wide opening width thereof is about 100˜1200 μm. The included angle between the side wall of the manifold 40 and a horizontal factor is about 54.74°. Thus, after etching, a manifold 40 with a back opening larger than a front opening is formed. Additionally, the manifold 40 connects to a fluid storage tank.

Next, the patterned sacrificial layer 22 is removed by HF, and the substrate 20 is subsequently etched with a basic etching solution, such as KOH, to enlarge the vacant capacity thereof, forming the chambers 42, as shown in FIG. 2F. Finally, the structural layer 24 is etched by plasma etching, chemical vapor etching, laser etching, or reactive ion etching (RIE), preferably RIE, to form the nozzles (43 and 43′) through the two structural layer regions respectively and connecting to the chambers 42.

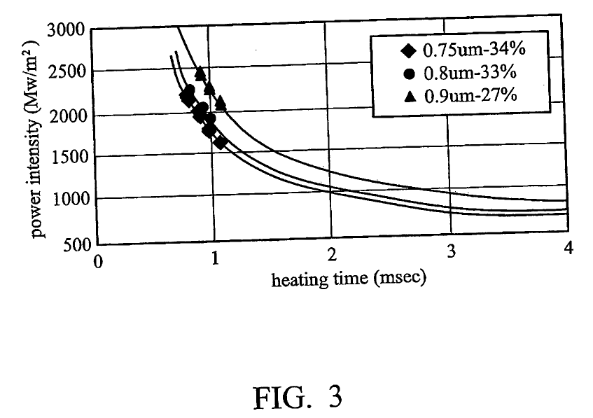

According to the heat transfer theory, J=−KΔT/L, when ΔT is fixed, heat flux (J) is directly proportional to heat transfer coefficient (K) but inversely proportional to transfer distance (L). The transfer distance (L) cited here represents the thickness of a structural layer of the invention. FIG. 3 is a diagram plotting turn-on power intensity against heating time of injection devices having structural layers with various thicknesses. The drawing shows that heating time increases as thickness of a structural layer increases to maintain fixed heat transfer efficiency.

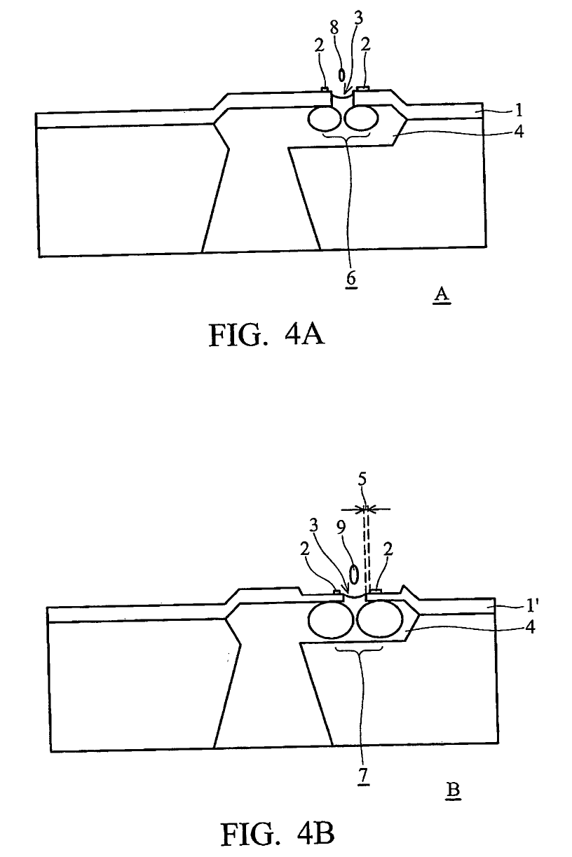

FIGS. 4A and 4B show different injection phenomena of the two fluid injection devices (A and B). The two device's heater size, nozzle size, chamber size, and the distance 5 between the nozzle 3 and the heater 2 are the same except that the thickness of the structural layer thereof is different. After a heating time period, the bubbles (6 and 7) of different sizes (6<7) are produced due to thickness variation between the structural layers (1 and 1′), thus injecting droplets (8 and 9) of different sizes (8<9).

FIG. 2F illustrates the injection phenomenon of the invention. The bubbles (44 and 46) are larger than the bubbles (48 and 50) because the thickness of the structural layer region 28 is thinner than another structural layer region 30. The droplets (8 and 9) of different sizes (8<9) are then injected out of the regions (28 and 30) respectively, wherein the diameter ratio thereof is about 1.15˜1.3.

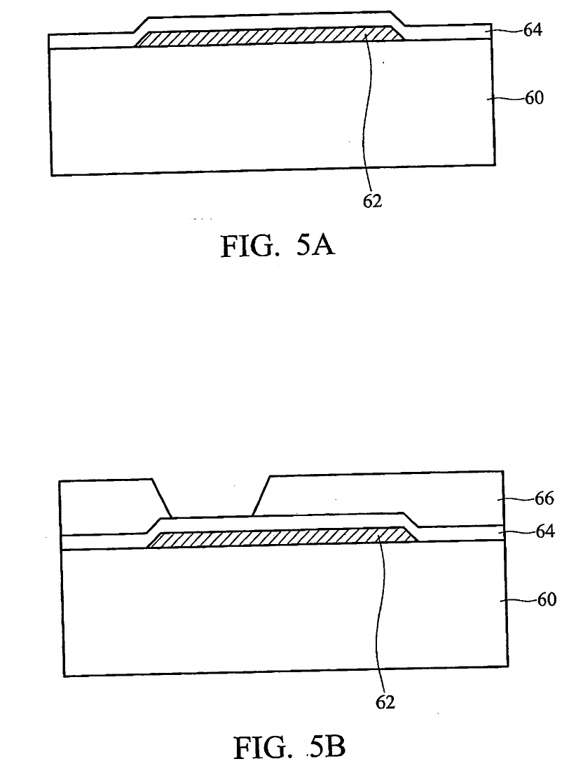

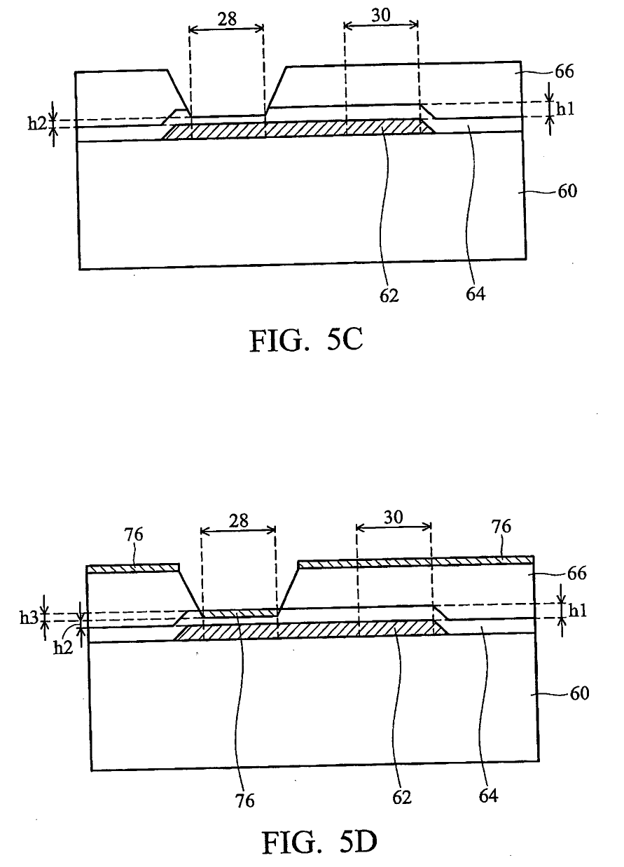

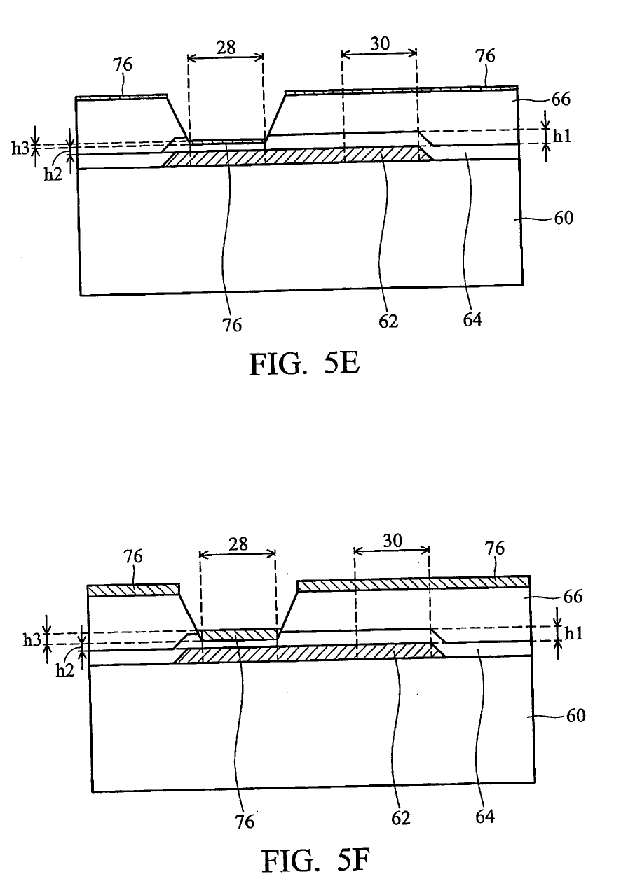

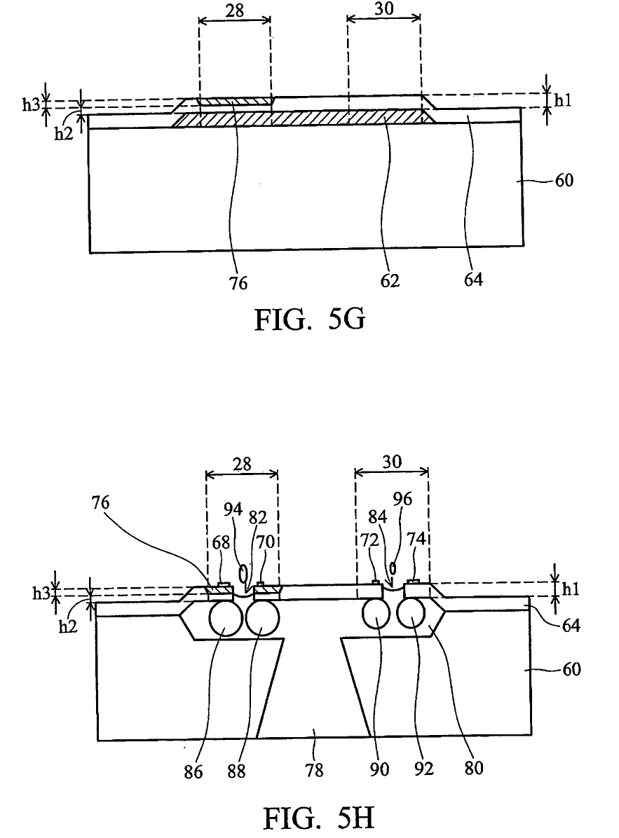

The second feature of the fluid injection device of the invention is illustrated in FIGS. 2A and 5H, wherein FIG. 5H is a cross section along the tangent line 5H-5H of FIG. 2A. Referring to FIG. 5H, the first structural layer 64 with heat transfer coefficient (k1) covering the chamber 80 has two regions (28 and 30) with different thicknesses (h2 and h1). The second structural layer 76 with heat transfer coefficient (k2) and thickness (h3) is then deposited on the first structural layer 64 with thickness (h2) to form two operating units to exhibit different heating and injection phenomena, wherein the materials of the first and second structural layers may be the same or not. The distinction between FIG. 2F and FIG. 5H is that the former discloses using a single structural layer with different thicknesses to alter the injection phenomenon, but FIG. 5H discloses using a stacked structural layer of different materials.

The above device structure is illustrated in FIG. 5H. The fluid injection device comprises a substrate 60, a manifold 78, a chamber 80, a first structural layer 64, a second structural layer 76, two sets of heaters (68, 70 and 72, 74), and a pair of nozzles (82 and 84).

The first structural layer 64 covers the substrate 60 and the chamber 80. The second structural layer 76 is deposited on the thinner first structural layer 64. The heaters (68, 70 and 72, 74) are installed on the first and second structural layers respectively and on both sides of the nozzles (82 and 84). The nozzles (82 and 84) are formed through the first and second structural layers respectively and connected to the chambers 80.

Referring to FIG. 5A˜5H, a method of fabricating the fluid injection device is provided. First, referring to FIG. 5A, a substrate 60 such as a silicon substrate is provided. The thickness of the substrate 60 is about 625˜675 μm. Subsequently, a patterned sacrificial layer 62, a predetermined region of a chamber, is formed on the substrate 60. The sacrificial layer comprises BPSG, PSG, or silicon oxide, preferably PSG. The thickness of the sacrificial layer is about 1˜2 μm.

Next, a first structural layer 64 with heat transfer coefficient (k1) and thickness (h1) is formed on the substrate 60 to cover the patterned sacrificial layer 62. The first structural layer 64 may be silicon nitride formed by CVD. The thickness of the first structural layer 64 is about 1.5˜2 μm. Subsequently, referring to FIG. 5B, a patterned photoresist layer 66 is formed on the first structural layer 64. Next, the first structural layer 64 uncovered by the patterned photoresist layer 66 is etched to form two regions (28 and 30) with different thicknesses, wherein the thickness variation therebetween is greater than 3500 Å. The thickness of the thicker region is h1 and the thinner is h2, as shown in FIG. 5C. Next, a second structural layer 76 with heat transfer coefficient (k2) and thickness (h3) is deposited on the first structural layer region 28 and the patterned photoresist layer 66. The second structural layer 76 may be silicon oxide, silicon nitride, or silicon oxide nitride formed by CVD. The first and second structural layers comprise different or the same materials formed with different sintered temperatures. Additionally, k1 is not equal to k2, and the relationship of h1, h2, and h3 may be h1=h2+h3 (as shown in FIG. 5D), h1>h2+h3 (as shown in FIG. 5E), or h1<h2+h3 (as shown in FIG. 5F). Various levels of heat transfer efficiency between the region 28 (stacked structural layer (64 and 76) with thickness (h2+h3)) and the region 30 (single structural layer 64 with thickness (h1)) is thus produced due to thickness variation or different materials thereof.

Another stacked structural layer fabrication may be performed. For example, after the etching procedure to form heating regions with different thicknesses of the first structural layer is performed, the patterned photoresist layer 66 is removed before the second structural layer is conformally deposited on the first structural layer. Next, another patterned photoresist layer is formed on the second structural layer. The second structural layer is then etched to form a stacked structural layer, wherein the second structural layer covering the thicker first structural layer is removed.

Next, referring to FIG. 5G, the patterned photoresist layer 66 is removed. The two sets of heaters (68, 70 and 72, 74) using for driving fluid are then installed on the first and second structural layers respectively and on both sides of subsequently formed nozzles. The heaters (68, 70 and 72, 74) comprise HfB₂, TaAl, TaN, or TiN, and are preferably TaAl.

Subsequently, a series of etching steps are performed. First, the back of the substrate 60 is etched to form a manifold 78 by anisotropic wet etching using NaOH, for example, as an etching solution, exposing the patterned sacrificial layer 62. The narrow opening width of the manifold 78 is about 160˜200 μm, and the wide opening width thereof is about 100˜1200 μm. The included angle between the side wall of the manifold 78 and a horizontal factor is about 54.74°. Thus, after etching, a manifold 78 with a back opening larger than a front opening is formed. Additionally, the manifold 78 connects to a fluid storage tank.

Next, the patterned sacrificial layer 62 is removed by HF, and the substrate 60 is subsequently etched with a basic etching solution, such as KOH, to enlarge the vacant capacity thereof, forming the chambers 80, as shown in FIG. 5H. Finally, the first and second structural layers are etched by plasma etching, chemical vapor etching, laser etching, or reactive ion etching (RIE), preferably RIE, to form the nozzles (82 and 84) through the two structural layer regions respectively and connecting to the chambers 80.

According to the heat transfer theory, when ΔT is fixed, heat flux (J) is directly proportional to heat transfer coefficient (K). FIG. 5H illustrates the injection phenomenon of the invention. After a heating time period, if h1=h2+h3 and k2>k1, a greater quantity of fluid can be injected out of region 28 than out of region 30 (94>96) due to formation of larger bubbles (86 and 88) than the other (90 and 92), wherein the diameter ratio of the injected droplets is about 1.15˜1.3.

While the invention has been described by way of example and in terms of preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fluid injection device, comprising:
a substrate;
a chamber formed in the substrate;
a structural layer covering the substrate and the chamber, wherein the structural layer covering the chamber has two regions with different thicknesses; and
at least two nozzles through the two structural layer regions respectively and connected to the chamber.

2. The fluid injection device as claimed in claim 1, wherein the structural layer comprises silicon nitride.

3. The fluid injection device as claimed in claim 1, wherein a thickness variation between the two structural layer regions is greater than 3500 Å.

4. The fluid injection device as claimed in claim 1, wherein the structural layer has different heat transfer efficiency.

5. The fluid injection device as claimed in claim 1, wherein droplets injected out of the two structural layer regions respectively have different sizes.

6. The fluid injection device as claimed in claim 5, wherein a diameter ratio of the injected droplets is about 1.15˜1.3.

7. A fluid injection device, comprising:
a substrate;
a chamber formed in the substrate;
a first structural layer with heat transfer coefficient (k1) covering the substrate and the chamber, wherein the first structural layer covering the chamber has a first region with thickness (h1) and a second region with thickness (h2), and a second structural layer with heat transfer coefficient (k2) and thickness (h3) is deposited on the first structural layer with thickness (h2); and
at least two nozzles through the first and second structural layer regions respectively and connected to the chamber.

8. The fluid injection device as claimed in claim 7, wherein the first structural layer comprises silicon nitride, and the second structural layer comprises silicon oxide, silicon nitride, or silicon oxide nitride.

9. The fluid injection device as claimed in claim 8, wherein the first and second structural layers are different materials or the same material formed with different sintered temperatures.

10. The fluid injection device as claimed in claim 7, wherein k1 is unequal to k2.

11. The fluid injection device as claimed in claim 7, wherein h1 is equal to h2+h3.

12. The fluid injection device as claimed in claim 7, wherein h1 is unequal to h2+h3.

13. The fluid injection device as claimed in claim 7, wherein the first and second structural layer regions have different heat transfer efficiency.

14. The fluid injection device as claimed in claim 7, wherein droplets injected out of the first and second structural layer regions respectively have different sizes.

15. The fluid injection device as claimed in claim 14, wherein a diameter ratio of the injected droplets is about 1.15˜1.3.

16. A method of fabricating a fluid injection device, comprising:
providing a substrate;
forming a patterned sacrificial layer on the substrate, wherein the patterned sacrificial layer is a predetermined region of a chamber;
forming a patterned structural layer on the substrate to cover the patterned sacrificial layer;
forming a patterned photoresist layer on the patterned structural layer;
etching the patterned structural layer uncovered by the patterned photoresist layer to form two structural layer regions with different thicknesses covering the patterned sacrificial layer;
removing the patterned photoresist layer;
forming a manifold through the substrate to expose the patterned sacrificial layer;
removing the patterned sacrificial layer to form a chamber; and
etching the structural layer to form at least two nozzles through the two structural layer regions respectively and connected to the chamber.

17. The method as claimed in claim 16, wherein the structural layer comprises silicon nitride.

18. The method as claimed in claim 16, wherein a thickness variation between the two structural layer regions is greater than 3500 Å.

19. The method as claimed in claim 16, wherein the structural layer has different heat transfer efficiency.

20. The method as claimed in claim 16, wherein droplets injected out of the two structural layer regions respectively have different sizes.

21. The method as claimed in claim 20, wherein a diameter ratio of the injected droplets is about 1.15˜1.3.

22. A method of fabricating a fluid injection device, comprising:
providing a substrate;
forming a patterned sacrificial layer on the substrate, wherein the patterned sacrificial layer is a predetermined region of a chamber;
forming a first structural layer with heat transfer coefficient (k1) on the substrate to cover the patterned sacrificial layer;
forming a patterned photoresist layer on the first structural layer;
etching the first structural layer uncovered by the patterned photoresist layer to form a first region with thickness (h1) and a second region with thickness (h2) covering the patterned sacrificial layer;
depositing a second structural layer with heat transfer coefficient (k2) and thickness (h3) on the first structural layer with thickness (h2);
removing the patterned photoresist layer;
forming a manifold through the substrate to expose the patterned sacrificial layer;
removing the patterned sacrificial layer to form a chamber; and
etching the first and second structural layers to form at least two nozzles through the first and second structural layer regions respectively and connected to the chamber.

23. The method as claimed in claim 22, wherein the first structural layer comprises silicon nitride, and the second structural layer comprises silicon oxide, silicon nitride, or silicon oxide nitride.

24. The method as claimed in claim 23, wherein the first and second structural layers are different materials or the same material formed with different sintered temperatures.

25. The method as claimed in claim 22, wherein k1 is not equal to k2.

26. The method as claimed in claim 22, wherein wherein h1 is equal to h2+h3.

27. The method as claimed in claim 22, wherein h1 is not equal to h2+h3.

28. The method as claimed in claim 22, wherein the first and second structural layer regions have different heat transfer efficiency.

29. The method as claimed in claim 22, wherein droplets injected out of the first and second structural layer regions respectively have different sizes.

30. The method as claimed in claim 29, wherein a diameter ratio of the injected droplets is about 1.15˜1.3.
